(19) United States
(12) Patent Application Publication
(10) Pub. No.: US 2014/0018714 A1
(43) Pub. Date: Jan. 16, 2014

(54) Device for washing and massaging human body parts

(71) Applicants: Marcello Dolenz, Oristano (IT); Alessia Rivers, Mount Kisco, NY (US)

(72) Inventors: Marcello Dolenz, Oristano (IT); Alessia Rivers, Mount Kisco, NY (US)

(21) Appl. No.: 13/549,608

(22) Filed: Jul. 16, 2012

(51) Int. Cl. A61H 7/00; A46B 9/02

(52) U.S. Cl. 601/136; 15/160

(57) ABSTRACT

A device for washing and massaging human body parts comprises a body (1) consisting of a central part (2) and extensions (3); the body having a front surface (4) and a rear surface (5). The front surface (4) is detailed with bristle-shaped projections (6) integral with the body (1) and the rear surface (5) are equipped with suction cups (7) for a removable attachment of the device to a fixed surface. The device can be applied to a shower wall, a bathtub or bidet.

### CROSS REFERENCE TO RELATED APPLICATIONS

“Not Applicable”

### BACKGROUND OF THE INVENTION

The following application is for a utility patent for the claimed invention. The utility is for use in the bathroom and should be consistent with washing and massaging the human body when in the bath, shower, bidet, or tub.

The purpose of the invention is to be used as a device for washing and massaging human body parts. Everyone has difficulty effectively washing and massaging (and without contortions) body parts such as the shoulders, back, and feet. The problem is that there is not currently any device that can be used in the bathroom that solves for this problem. There currently no devices available for washing and massaging the human body that can be temporarily affixed to other bathroom utilities. Also there currently are not any devices available that can both wash and massage difficult to reach areas of the body that are aesthetically appealing.

### BRIEF SUMMARY OF THE INVENTION

The utility is for use in the bathroom and should be consistent with washing and massaging the human body when in the bath, shower, bidet, or tub.

The purpose of the invention is to be used as a device for washing and massaging human body parts. It is commonly known that certain areas of the human body are not easily reached by the same person that is to be washed and/or massaged. Everyone has difficulty effectively washing and massaging (and without contortions) body parts such as the shoulders, back, and feet. The problem is that there is not currently any device that can be used in the bathroom that solves for this problem.

Therefore, an objective of the presented invention is to provide a device that will enable a person to achieve washing and massaging their own body parts such as their shoulders, back, and feet without the assistance of others. Another objective is to make such a device that will solve the aforementioned problems in a convenient and effective manner. The device can be temporarily affixed to other bathroom utilities creating an effective and simple means to washing and massing difficult to reach body parts. It can be affixed juxtapose or perpendicular to the human body part and the part can then be rubbed against the device in order to cleanse and massage the respective body part.

Also, there currently are not any devices available that can both wash and massage difficult to reach areas of the body that are aesthetically appealing. Hence, another objective is to make a device shaped in such a way as to convey good and beneficial feelings. In doing so, an objective of the invention is to provide a device for washing and massaging human body parts that have a pleasing appearance from an aesthetic point of view and is psychologically reassuring.

### DETAILED DESCRIPTION OF THE INVENTION

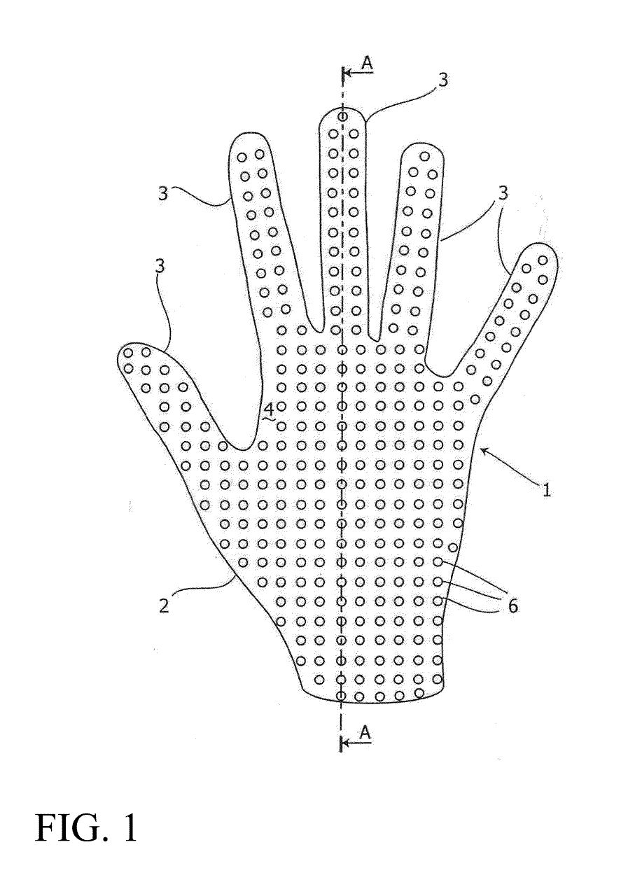

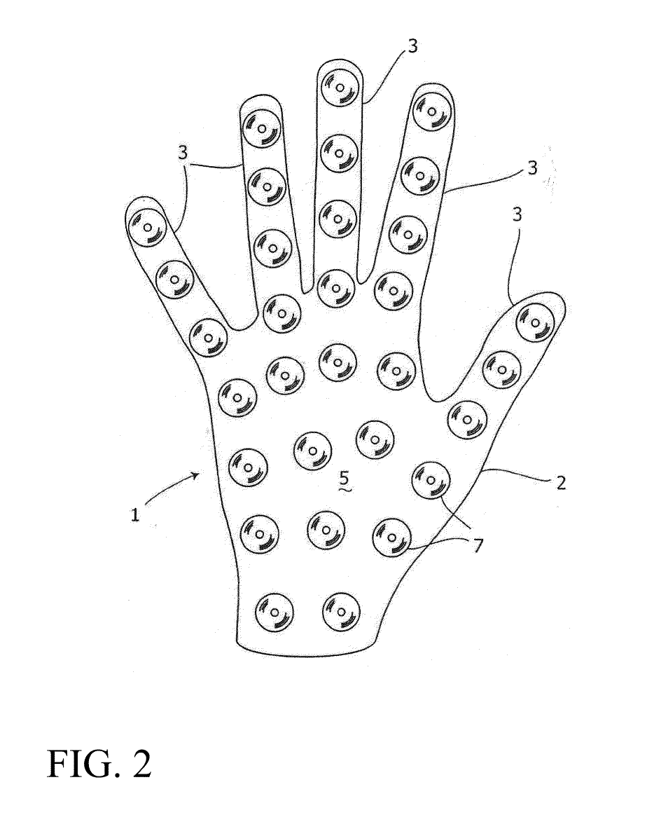

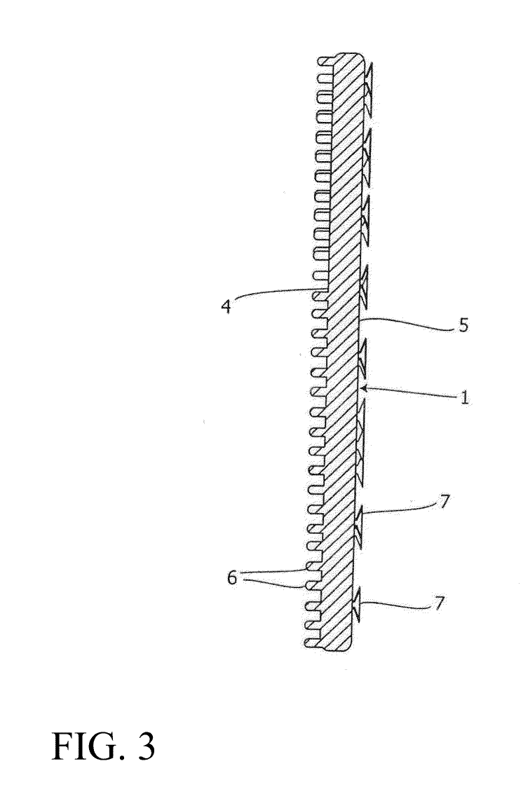

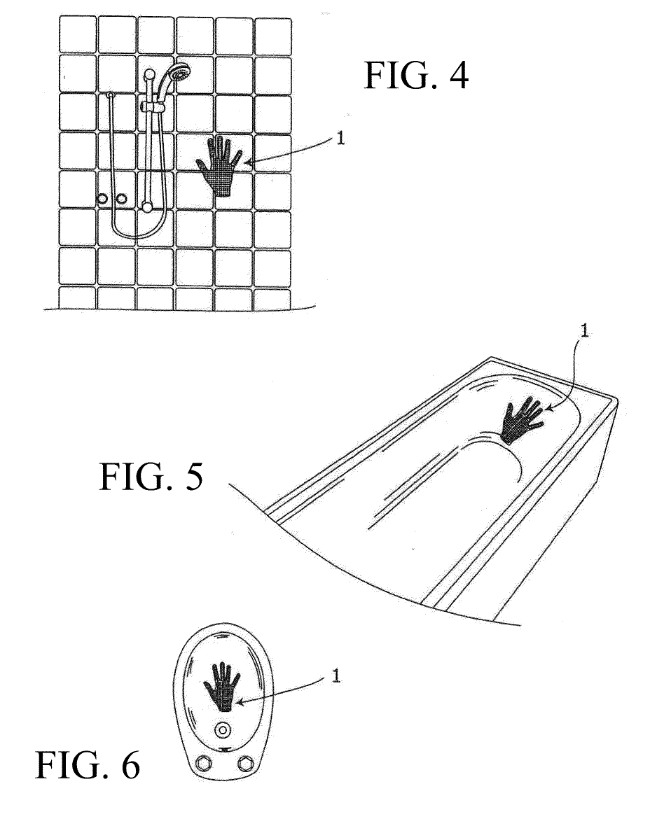

The invention is stated in claim 1 and in the claims depending on it. It will be understood more fully from the following description made with reference to the accompanying drawings, wherein: FIG. 1 is a front plan view of the device for washing and massaging human body parts according to the invention; FIG. 2 is a rear plan view of the device of FIG. 1; FIG. 3 is a cross-section view made along the lines A-A in FIG. 1; FIG. 4 is a fragmentary frontal view of a shower in which the device according to the invention are applied; FIG. 5 is a fragmentary perspective view of a bathtub in which the device according to the invention is applied; and FIG. 6 is a plan view of a bidet in which the device according to the invention is applied.

Referring to FIGS. 1 to 3, the device for cleaning and massaging of body parts according to the invention is shown schematically in a front plan view, in a rear plan view and in a cross-section view. The device comprises a body 1 consisting of a central part 2 and extensions generally indicated as 3. The body [Component 1], which in the example chosen to describe the invention is in the shape of human hand, is provided with a front surface [Component 4] and a back surface [Component 5]. The front surface [Component 4] has bristle-shaped projections [Component 6], which can suitably be integrated with the body [Component 1]. The rear surface [Component 5] is equipped with suction cups [Component 7] for a removable attachment of the device to a wall (according to the invention), even in the presence of water, as discussed below. The projections [Component 6] and the suction cups [Component 7] are best shown in FIG. 3 which is a cross-section made along the lines A-A in FIG. 1.

Advantageously, the front surface [Component 4] of the body [Component 1] is convex so as to facilitate washing and massaging of body parts that are placed in contact with such front surface. Although not shown in detail, the bristle-shaped projections [Component 6] have different sizes in different parts of the front surface of the device to allow efficient contact between various parts of the human body and the front surface [Component 4] of the body [Component 1], especially because it is convex. The rear surface [Component 5] is flat so as to facilitate the wall attachment of the device.

The choice of the shape of a human hand for the body [Component 1] of the device according to the invention gives it a pleasant appearance from an aesthetic point of view and psychologically reassuring. Furthermore, the shape of the human hand for the body [Component 1] causes the extensions [Component 3] to be similar to fingers able to exercise a massage action that is particularly effective in promoting blood circulation. In washing, the hand-shaped body [Component 1] allows a cleanser that the user has previously poured on the device to be retained and distributed optimally on the body parts.

The body [Component 1] can be made entirely of natural or synthetic rubber and its derivatives with a degree of softness and density that is chosen according to the sensitivity of the areas of skin to which the device is intended. Obviously, the choice of the colors of the device is wide to enable its harmonization with the environment in which it is applied.

Areas of application of the device are shown in FIGS. 4 to 6, which are respectively a fragmentary front view of a shower, fragmentary perspective view of a bathtub and a plan view of a bidet. It should be obvious that the use of the device in the shower and the bathtub, as shown in the figures, it is particularly intended for the surfaces of the shoulders and back, while its use in the bidet is designed to wash and massage the foot sole. It is clear that the size of the device may be selected as desired, being convenient for the user and the application of the device.

1. A device for washing and massaging human body parts, characterized in that the device comprises a body (1) consisting of a central part (2) and extensions (3), the body having a front surface (4) and a rear surface (5), the front surface (4) being provided with bristle-shaped projections (6) integral with the body (1) and the rear surface (5) being equipped with suction cups (7) for a removable attachment of the device to a fixed surface.

2. The device according to claim 1, characterized in that the front surface (4) of the body (1) is convex and the back surface (5) is flat.

3. The device according to claim 1, characterized in that the body (1) has the shape of a human hand.

4. The device according to claim 1, characterized in that the device is made entirely of natural or synthetic rubber and its derivatives.

5. The device according to claim 1, characterized in that the bristle-shaped projections have different sizes in different parts of the front surface of the device.

6. The device according to claim 1, characterized in that said fixed surface to which the device is removable attached is that one of a wall of a shower.

7. The device according to claim 1, characterized in that said fixed surface to which the device is removable attached is the internal one of a bathtub or bidet.
